(19) United States
(12) Patent Application Publication
(10) Pub. No.: US 2022/0351105 A1
(43) Pub. Date: Nov. 3, 2022

(54) METHODS AND SYSTEMS FOR SCORING, SELECTING AND BOOKING ANIMALS FOR CASTING

(71) Applicant: PETS ON Q INC., Los Angeles, CA (US)

(72) Inventor: Colleen WILSON, Los Angeles, CA (US)

(21) Appl. No.: 17/734,554

(22) Filed: May 2, 2022

Related U.S. Application Data
(60) Provisional application No. 63/183,589, filed on May 3, 2021.

(51) Int. Cl. G06Q 10/06

(52) U.S. Cl. CPC G06Q 10/06311

(57) ABSTRACT

A method of booking an animal for an act or campaign, facilitated by a booking platform comprising the steps of receiving an animal booking request from a customer, wherein the request includes at least one or more metrics associated with the booking request, receiving and validating an animal listing request from an owner, wherein the validated details are listed in a resource directory, determining a metrics similarity score between the booking metrics and the listed metrics for review and access to both the customer and the owner, facilitating communication between the customer and the owner to incorporate negotiation terms of the engagement, and receiving the payment as in part of the confirmation of the booking transaction.

### FIELD OF THE INVENTION

The present invention relates to a booking platform. In particular, the invention relates to a booking platform for scoring, selecting and booking animals for an engagement.

### BACKGROUND

Many media platforms often require casting animals performing various activities as part of a marketing campaign. As part of the process, an interested party needs to browse various platforms or contact people to find an animal with the preferred skills and talent that fit the campaign. Oftentimes a thorough background assessment is not facilitated to determine a perfect match. In case, an animal that is picked does not end up matching the requirements, it can be an operational and logistical hazard for the interested party and an inhumane drill for the animal.

Thus, in light of the above discussion, there is a need for an automated centralized platform that facilitates a transparent booking of animals.

### OBJECTS OF THE INVENTION

The primary object of the present invention is to provide an animal booking platform that comprises a series of extensive steps that includes validation and evaluation of the background of the customer, the animal, and the owner.

Another object of the present invention is to provide a platform that automates the process of casting and finding qualified animals by booking entities in a timely and easy manner.

Yet another object of the present invention is to provide a platform that implements processes/tools for better animal safety and treatment including, but not limited to, compliance with regulatory and ethical treatment standards of animal influencers or set animals.

An additional object of the present invention is to collect and analyze data related to the attractiveness and payback of market communication campaigns or tasks related to animal influencers or set animals.

Another object of the present invention is to expose animal influencers or set animals to commercial opportunities based on the business outcomes of past engagements are recommended to booking entities.

Further object of the present invention is to define mechanisms for providing win-win scenarios and optimized monetization suggestions based on business criteria and available data.

### SUMMARY

Various embodiments disclose methods and systems for booking animals for an engagement.

In an embodiment, a method comprising an animal booking platform incorporated in a server system is disclosed. The method includes receiving an animal listing request from an owner, uploading one or more records associated to at least a part of the animal listing request, validating, the animal listing request based at least in part on one or more submitted records provided by the owner, receiving scoring parameters associated with the animal listing request, and computed qualification score for the animal that qualifies the pre-determined standards and obligations of the engagement, wherein the qualification score is computed based on the data extracted from the third party evaluation data providers, listing the animal listing request after successful validation and determination of qualified metrics as approved talent and sending a notification to the owner with the status of the listing and result of the validation. Further, the server system includes receiving an animal booking request from a customer for booking an animal for an engagement, determining, a similarity score and generating a list of qualifying animals in accordance with the animal booking request provided by the customer, facilitating selecting and booking of at least one qualifying animal, and facilitating receipt of at least a part payment for the animal booking request from the customer to the owner.

In another embodiment, a server system is disclosed. The server system includes a memory configured to store instructions, and a processor configured to execute the instructions stored in the memory and thereby cause the server system to receive an animal listings request from an owner, upload one or more records associated to at least a part of the animal listing request, validate the animal listing request based at least in part on one or more submitted records provided by the owner, receive scoring parameters associated with the animal listing request, and computed qualification score for the animal that qualifies the pre-determined standards and obligations of the engagement, wherein the qualification score is computed based on the data extracted from the third party evaluation data providers, list the animal listing request after successful validation and determination of qualified metrics as approved talent, and send a notification to the owner with the status of the listing and result of the validation.

In yet another embodiment, a system is disclosed. The system includes a memory configured to store instructions, a communication interface and a processor in communication with the memory and the communication interface, the processor is configured to execute the instructions stored in the memory and further comprises, a scoring module configured to receive scoring parameters which include at least one of quantitative, qualitative, extraneous factors, and qualification score computed for the animal that qualifies the pre-determined standards and obligations associated with an animal for performing an activity, wherein the qualification score is computed based on the data extracted from the third party evaluation data providers a metrics module configured to compute value metrics from one or more value scores, a feedback & rating module configured to receive and collect ratings and qualitative feedback in response to the information of listings and provide alternative recommendations based on the feedback, a logistics engine configured to track, and generate reports for successful bookings and enables deep search capability to compare animals that match the talent criteria with the associated animal booking request, a validation module configured to validate the uploaded records to determine content accuracy of the prior to display of the animal listing, a fitness determination module configured to generate a health, wellness, and fitness profile and health score for animals that choose to participate in an engagement, and a payment processing module configured to facilitate receipt of at least a part payment for the booking made by the customer.

### BRIEF DESCRIPTION OF DRAWINGS

For a more complete understanding of example embodiments of the present technology, reference is now made to the following descriptions taken in connection with the accompanying drawings in which:

FIG. 1 represents an example representation of an environment related to at least some example embodiments of the present disclosure;

FIG. 2 is a simplified block diagram of a server system, in accordance with an embodiment of the present disclosure;

FIGS. 3A to 3D, collectively, represent an example representation of a process to be followed for submitting animal details with corresponding User Interfaces (UIs), in accordance with an example embodiment of the present disclosure;

FIGS. 4A to 4F, collectively, represent an example representation of a process to be followed for booking an animal with corresponding User Interfaces (UIs), in accordance with an example embodiment of the present disclosure;

FIG. 5 is a flowchart of an example of the method operations involved for an owner;

FIG. 6 is a flowchart of an example of the method of operations involved for a customer; and

FIG. 7 is a simplified block diagram of an electronic device capable of implementing the various embodiments of the present disclosure.

The drawings referred to in this description are not to be understood as being drawn to scale except if specifically noted, and such drawings are only exemplary in nature.

### DETAILED DESCRIPTION OF DRAWINGS

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various embodiments disclose methods and systems for scoring, selecting and booking animals for performing an act or activity or commercial campaigns.

In various example embodiments, the present disclosure describes an animal booking platform that facilitates the booking of an animal by determining the authenticity of the information provided for an animal, generating a qualification score of an animal, and determining the matched animal for a customer's request by computing a similarity score. To use the animal booking platform a customer or an owner may need to register first by providing user profile data on the animal booking platform. Upon registering with the animal booking platform, the customer can search for an animal that matches the requirements and the owner can upload the details for an animal available to perform in a campaign.

The animal booking platform further facilitates generating a list of qualifying animals in accordance with criteria provided by the customer based on the details uploaded by the owner and at least based on part of the booking requirement provided by the customer. The animal booking platform evaluates and validates the uploaded details by the owner. In at least one example embodiment, the animal booking platform may send the uploaded details to a certified expert or third-party evaluation systems to determine the authenticity of the records. The accuracy of the information is verified by the animal booking platform prior to listing the animal. The animal booking platform may then send a notification to the owner's device after verification.

The animal booking platform enables the customer to enter various metrics associated with the engagement such as type of activity, required talent and/or skill details for hiring an animal etc. The animal booking platform processes the received details by determining a similarity score and lists the matched animals for the customer. The similarity score is determined based on quantitative factors of the animal, qualitative factors of the animal and other extraneous factors, and is computed based on certain rules or weighting of the factors to predict the likely fit of an animal for the defined task as requested by the customer. The generated list is displayed on the customer device, wherein the customer can book the animal using the animal booking platform.

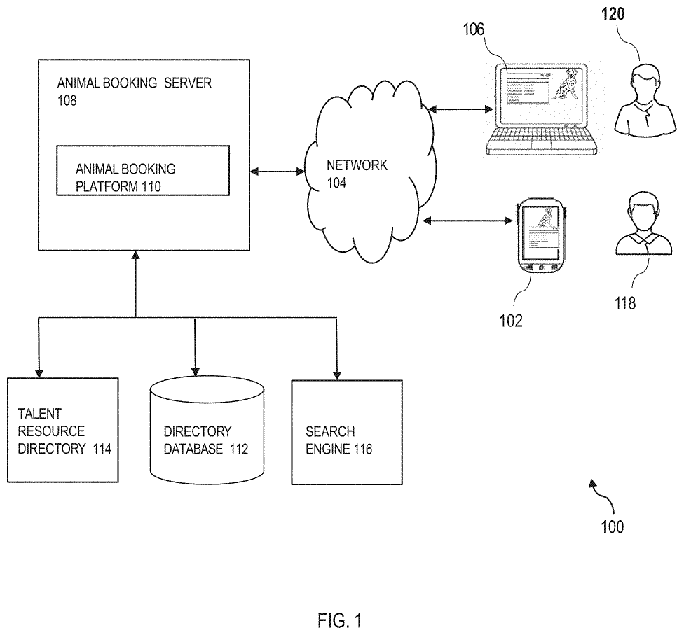

FIG. 1 is an illustration of an environment 100 related to at least some example embodiments of the present disclosure. Although the environment 100 is presented in one arrangement, other embodiments may include the parts of the environment 100 (or other parts) arranged otherwise depending on, for example, booking of animals and access management of booked animals, etc. The environment 100 includes, but is not limited to, a wireless communication network (e.g., a network 106) that connects entities such as plurality of customers (e.g. a customer 118), a plurality of owners (e.g. an owner 120), and a server 108.

The network 106 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 104 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof.

In one embodiment, the customer 118 can access the animal booking platform 110 through a web browser or a mobile application installed on the customer device 102. Similarly, the owner 114 can also access the animal booking platform 110 through the web browser or the mobile application installed on the owner device 106.

In one example embodiment, the owner 120 may access the animal booking platform 110 for uploading animal information. The owner 120 sends a listing request to the animal booking platform 102 along with the animal and owner information that needs to be listed. The animal information may include but is not limited to animal type, animal physiology, animal biochemistry, data describing a physical condition of the animal, data describing the medical diagnosis of the animal, location, activity strength, temperament testing, training level and skills etc.

The owner information may include but is not limited to Personal Identification Information (PII), social media data, Know Your Customer (KYC) data, payment data, market abuse data, and Human Resource (HR) data.

The animal booking platform 110 then evaluates and validates the uploaded details and may then send a notification to the owner's device 106. The notification may include a message indicating the authenticity check status of the uploaded details. Optionally, on successful validation, the notification may also include tracking information associated with the animal listing for the owner 120 to view the status of a booking.

In an embodiment, the server 108 may reside software backend APIs corresponding to the animal booking platform 110 which instructs the server 108 to perform one or more operations described herein. In addition, the server 108 should be understood to be embodied in at least one computing device in communication with the network 104, which may be specifically configured, via executable instructions, to perform as described herein, and/or embodied in at least one non-transitory computer-readable media.

The animal booking platform 110 is an application/tool resting at the server 108. In one embodiment, the server 108 is configured to host and manage the animal booking platform 110 and communicate with the electronic devices, such as the customer device 102 and the owner device 106 for providing an instance of the animal booking platform 110.

In an embodiment, the server 108 is configured to receive an animal listing request from an owner. The animal listing request includes at least an animal information comprising at least an animal type, animal physiology, animal biochemistry, data describing a physical condition of the animal, data describing the medical diagnosis of the animal, location, activity strength, temperament testing, training level and skills. The server 108 is configured to validate the animal listing request based at least in part on one or more submitted records provided by the owner. The records may include supporting information for the animal in the form of text, image, audio, video or any combination thereof. The validation is performed to facilitate determining the content accuracy prior to display and listing of the animals. The server 108 may send the animal listing request along with records of uploaded details to a certified expert or third-party evaluation systems to determine authenticity of the records and the animal After validation, the server 108 is configured to cause display and list the validated animals as approved talent. The server 108 may send a notification to the owner with the status of the listing and result of the validation.

The server 108 is configured to receive an animal booking request from a customer 118 for booking an animal for an engagement. Wherein, the engagement can include but is not limited to casting, performing at an event, marketing campaign or any other activity that fulfills the governmental licensing requirements and/or social/moral obligations. The animal booking request includes one or more metrics associated with the activity and required talent and/or skill details for the engagement. The server 108 then processes the received details by determining a similarity score and lists the matched animals on the customer device for the customer 118 to select and book one or more performing activities. The server 108 is then configured to generate a list of qualifying animals in accordance with criteria provided by the customer at least based on part of the booking request. The server system is configured to facilitate receipt of at least a part payment for the animal booking request from the customer 118.

In one embodiment, the server 108 also lists a booking fee for each listed animal. In at least one example embodiment, the booking fee can be an amount suggested by the customer 118 (as a bid price), or an amount proposed by the owner 120 (as an offer price). Further, the difference between the bid price and the offer price is factored into the determination of the similarity score used to compile the list of match animals. In another example embodiment, the server 108 can also calculate a suggested viable booking fee for consideration by owner 120 and customer 118 based on past bookings.

In one embodiment, the server 108 enables a certified expert to conduct meetings with the owner, work with the animals, inquire about the owner and other accomplices and/or refer to external databases to validate the authenticity of the animal details and the animal's condition.

In one embodiment, the server 108 determines a similarity score based on quantitative factors of the animal such as but is not limited to a number of followers on social media platforms, qualitative factors of the animal such as but is not limited to affinity towards performing certain skills, and other extraneous factors (e.g., Retrievers more popular than Beagles), and computed based on certain rules or weighing of the factors to predict the likely fit of an animal for the defined task as requested by the customer 118. In one embodiment, the rules or weighting of factors are constantly updated based on the machine learning of the business outcome of past engagements of a particular animal or similar engagements involving similar customers with similar animals.

Further, the server 108 is configured to store the list of qualified animals in a talent resources directory 114, which contains details associated with all booking transactions and their business outcome, wherein the details include, but are not limited to, customer details, owner details, booking id, payment, training progress, animal type, animal physiology, animal biochemistry, data describing a physical condition of the animal, data describing the medical diagnosis of the animal, location, activity strength, temperament testing, training level and skill etc.

In at least one example embodiment, the talent resources directory 114 includes a directory database 112 to store the one or more details about the qualifying animals, wherein the talent resources directory 114 is stored as a directory tree structure that includes nodes comprising a designated category for each node and branches comprising links between the nodes, and generating one or more pointers. Each pointer corresponds to a specific node and the pointer links the specific node to an item of data within the directory database. All pointers associated with the specific node link related items of data corresponding to the designated category of the specific animal information. The talent resources directory 114 further includes a search engine configured to dynamically generate search results from the directory database 112 based on the customer's request.

In one embodiment, the server 108 is configured to facilitate negotiation, wherein the customer 118 and the owner 120 can negotiate mutually acceptable terms for the engagement and then enforces them automatically after the owner 120 and the customer 118 have agreed on the terms are of the engagement.

In one embodiment, the server 108 is configured to determine the fitness of the animal based on the submitted records. The server 108 may also track the vitals of the animal for evaluating the health, wellness, and fitness status for participation during the engagement term. Health-related data and laboratory results may be reviewed by qualified medical personnel in order to determine their eligibility for participation during the engagement and the reviewed results are sent to the customer and the owner.

In an embodiment, the server 108 is configured to monitor and record the customer's bookings to generate an invoice for successful bookings. Further, the information stored in the directory database 112 of the talent resources directory 114 may form the basis of a charging model. Several charging models may be employed. The server 108 may impose a subscription fee for the use of the animal booking platform 110 by the customer 118 to access the information stored in and processed by the talent resources directory 114.

In one embodiment, the server 108 is configured to place a hold on a processing fee from the transaction amount. The processing fee is deducted by the server 108 for facilitating the booking of an animal. The server 108 calculates a payment amount for the owner based at least in part on the processing fee and the transaction amount. Specifically, the processing fee is deducted from the transaction amount to determine the payment amount for the owner 120. Thereafter, the server system is configured to process the payment amount to the owner 120.

In one embodiment, the server 108 is configured to collect various scoring parameters received from the user (e.g. the owner 120), wherein the scoring parameters could include the quantitative, qualitative, and extraneous factors, and could also include a qualification score computed by the third-party evaluation data providers that qualify the pre-determined standards and obligations associated with an animal for performing an activity. The list of qualified metrics of the animals is stored as approved talent or qualified list. The server 108 then computes value scores (VA) for the received parameters that are stored in the talent resources directory for further operations. The server 108 is configured to compute value metrics (VM) from the generated value scores. The value metrics are displayed to the user (e.g. customer 118) with the animal listing(s) for the user to choose an animal as per one's requirement.

In an embodiment, the server 108 is configured to receive one or more campaign metrics described by the customer 118 and generate generic deliverables, individual price points, the scope of work for individual talent etc., wherein the campaign metrics (CM) may include campaign advertisements (CA) for marketing.

In an embodiment, the server 108 is configured to analyze content collected from any of the social media account associated with the owner and/or the animal to determine a frequency of references and generates a report including information based on the analysis. The report may include details of visibility, followers, influencer references, social engagement value based on the plurality of social media posts and the like.

In an embodiment, the server 108 is further configured to receive and collect ratings and qualitative feedback (QF) in response to the information of listings. Based on the customer's feedback the server 108 may provide alternative recommendations. The server 108 further facilitates the customer to provide a vote (upvote/downvote) and provide feedback on the content accuracy of the information that was provided to the customer 118 and the feedback collected from the customer 118 is stored to provide alternative recommendations.

The server 108 is further configured to collect quantitative post-engagement data (QD) related to the outcome of the engagement in terms of the fulfillment of the stated objectives of the customer 118 and owner 120. The amalgamation of the qualitative feedback (QF) and quantitative post-engagement data (QD) can be in the calculation of value metrics (VM), employed during future animal selection recommendations for similar successful bookings.

It is noted that the instructions (or the executable code) configuring the animal booking platform 110 are stored in a memory of the server 108 and the instructions are executed by a processor (for example, a single-core or a multi-core processor) included within the server 108. Accordingly, even though the various functionalities for listing and booking of animals for an engagement is explained with reference to or being performed by the animal booking platform 110, it is understood that the processor in conjunction with the code in the memory is configured to execute the various tasks as enabled by the instructions of the animal booking platform 110.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of the environment 100 may perform one or more functions described as being performed by another set of systems or another set of devices of the environment 100.

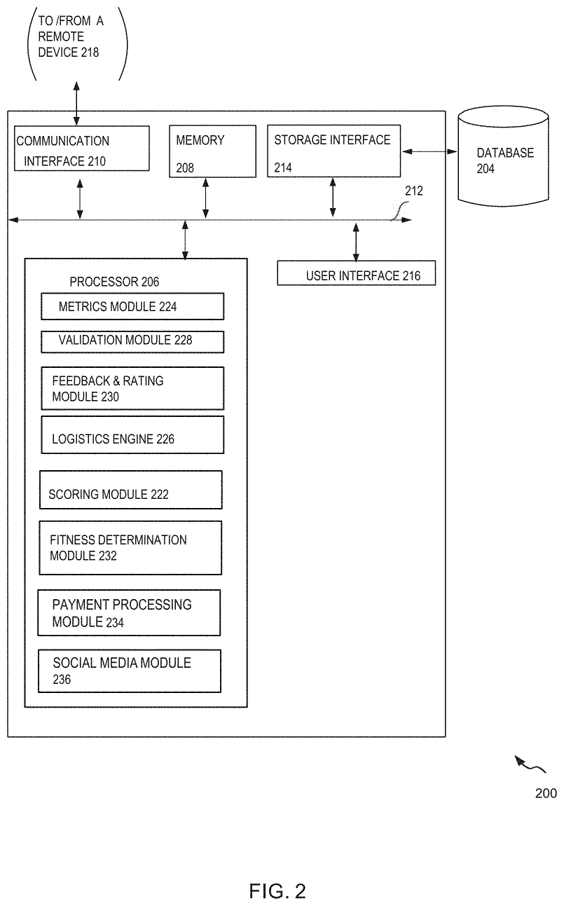

FIG. 2 is a block diagram of a server system 200, in accordance with an example embodiment. In some embodiments, the server system 200 is embodied as a cloud-based and/or SaaS-based (software as a service) architecture. The server system 200 is an example of the server 108 explained with reference to FIG. 1. The server system 200 is configured to enable listing and booking of animals for an engagement. In an embodiment, the server system 200 includes a computer system 202 and a database 204. The computer system 202 further includes at least one processor 206 for executing instructions, a memory 208, a communication interface 210, and a user interface 216 that communicate with each other via a bus 212.

In some embodiments, the database 204 is integrated within computer system 202. For example, the computer system 202 may include one or more hard disk drives as the database 204. A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

In one embodiment, the database 204 is configured to store profile data associated with each user of the one or more users, such as the customer 118 and the owner 120. The database 204 is configured to store at least details in part associated with each past, present and future user and/or booking transaction. The details may include logistics, evaluation details, computational metrics, scores, booking id, payment amount, post-engagement outcome, evaluation, status, etc. In an embodiment, the database 204 is also configured to store a plurality of predefined rules for booking an animal. The plurality of pre-defined rules include, but are not limited to a set of rules defined for social or moral obligations, a set of rules defined for cancellation policy etc. Additionally, the database 204 is configured to store one or more feedbacks that are provided for a booking by the owner 120 or the customer 118.

The processor 206 includes suitable logic, circuitry, and/or interfaces to execute operations for receiving a request from a user (e.g., the owner 120, the customer 118) for listing or booking of animal Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208, as described herein. In another embodiment, the memory 208 may be realized in the form of a database server or cloud storage, without departing from the scope of the present disclosure.

The processor 206 is operatively coupled to the communication interface 210 such that the processor 206 is capable of communicating with the remote device 218 such as, the customer device 102, the owner device 106, or communicating with any entity connected to the network 104 (as shown in FIG. 1). Further, the processor 206 is operatively coupled to the user interface 216 for interacting with the customer 118 and the owner 120.

The communication interface 210 may be typically configured to facilitate one or more user interfaces for receiving/transmitting a broadcast signal and/or broadcast associated with one or more users through an electronic message, particularly for finalizing the terms and conditions of a booking transaction and campaign metrics. The electronic message may include an e-mail, text message (e.g. a short messaging service (SMS) message, or a multimedia messaging service (MMS) message,) a chat message associated with an online chat service, conferencing means and so on.

The user interface module 212 is configured to present one or more UIs for facilitating booking of the animals using the platform. The UI module 212 includes an input interface and an output interface. The input interface is configured to receive requests or entries provided by the users (e.g. customer 118 or owner 120) through the computing devices. Examples of the input interface may include, but are not limited to a keyboard, a mouse, a joystick, a keypad, a touch screen, soft keys, a floppy disk, a pen drive, a hard drive and the like. The output interface is configured to display the UIs for facilitating booking transactions of an animal Examples of the output interface may include, but are not limited to, a display such as a light emitting diode (LED) display, a thin-film transistor (TFT) display, a liquid crystal display, an active-matrix organic light-emitting diode (AMOLED) display, and the like.

It is noted that the server system 200 as illustrated and hereinafter described is merely illustrative of an apparatus that could benefit from embodiments of the present disclosure and, therefore, should not be taken to limit the scope of the present disclosure. It is noted that the server system may include fewer or more components than those depicted in FIG. 2.

The processor 206 includes a scoring module 222, a metrics module 224, a logistics engine 226, a validation module 228, a feedback and rating module 230, a fitness determination module 232, a payment processing module 234 and a social media module 236. It should be noted that components, described herein, can be configured in a variety of ways, including electronic circuitries, digital arithmetic and logic blocks, and memory systems in combination with software, firmware, and embedded technologies.

The scoring module 222 includes suitable logic, circuitry, and/or interfaces to execute computer-readable instructions for collecting various input parameters received from the user (e.g. the owner 120 or the customer 118), wherein the parameters may be gathered from input entries submitted by the user or may be retrieved from other social media profiles associated with the user or may be periodically imported from a third party analytical or evaluation data providers.

The scoring module 222 is further configured to receive scoring parameters which include at least one quantitative, qualitative, extraneous factors, and qualification score (QS) computed for the animals that qualify the pre-determined standards and obligations associated with the engagement, wherein the qualification score is computed based on the data extracted from third party evaluation data providers. The list of qualified metrics of the animals is transmitted to the scoring module as approved talent (AT). The scoring module 222 then computes a value score (VS) for the received parameters that is stored in the talent resources directory 114.

The scoring module 222 may include a semantic analysis interface, configured to perform various analysis operations to achieve a semantic level of understanding of the algorithm that is embedded as needed to the scoring module by analyzing and comparing various machine learning and/or data analytic techniques.

The metrics module 224 is in communication with the scoring module 222. The metrics module 224 includes suitable logic, circuitry, and/or interfaces to execute computer-readable instructions for computing value metrics (VM) from the value scores generated by the scoring module 222. The value metrics are displayed to the user (e.g. the customer 118 or the owner 120) with the animal listing(s) for the user to choose an animal as per one's requirement.

The metrics module 224 is further configured to receive one or more campaign metrics described by the customer 118 and generate generic deliverables, individual price points, scope of work for individual talent etc. Each campaign metrics (CM) may include campaign advertisements (CA).

The feedback & rating module 226 is in communication with the similarity scoring module 222 and metrics module 224. The feedback & rating module 226 includes suitable logic, circuitry, and/or interfaces to execute computer-readable instructions for receiving and collecting ratings and qualitative feedback (QF) in response to the information of listings and provide alternative recommendations based on the feedback.

The feedback & rating module 226 is further configured to collect quantitative post-engagement data (QD) related to the outcome of the engagement in terms of the fulfillment of stated objectives by the customer 118 and the owner 120. The amalgamation of the qualitative feedback (QF) and quantitative post-engagement data (QD) can be used by the scoring module 222 in the calculation of value metrics (VM) to provide future animal booking recommendations for similar successful bookings.

The logistics engine 228 is a centralized engine that includes suitable logic, circuitry, and/or interfaces to execute computer-readable instructions to track, and generate reports for bookings that do not incur logistics, statutory or social/moral conflicts. The report details may include an animal's location, availability, licensing and background, behavioral data, temperament, and the like. The generated reports are transmitted to the user (e.g. customer 118 or owner 120) for review.

The logistics engine 228 is further configured to enable deep search capability to compare animals that match the talent criteria with the associated booking offers. The listings include details of one or more animals with individual campaign metrics matching the engagement.

The validation module 230 is in communication with the logistics engine 228. The validation module 230 includes suitable logic, circuitry, and/or interfaces to execute computer-readable instructions for validating the uploaded or received details related to an animal or the owner. Validation is performed to determine the content accuracy prior to the listing of the animals. The validation module 230 is configured to receive evidence records from the owner 118 for verifying the listing request. The evidence record may include, but is not limited to textual content (e.g. printed or hand written), recorded media content (e.g. voice or video), photographs, live demonstration, or any combination thereof.

The fitness determination module 232 includes suitable logic, circuitry, and/or interfaces to execute computer-readable instructions for generating health, wellness, and fitness profile and health score for animals that choose to participate in an engagement. The fitness determination module 232 may create a comparative analysis during the engagement.

The payment processing module 234 includes suitable logic and/or interfaces for managing payment transactions of the booking of an animal for an engagement. The payment processing module 234 is configured to determine a total cost for the booking agreed by the owner and the customer through the owner's and customer's input. Further, the payment processing module 234 is configured to facilitate receipt of at least a part payment for the booking made by the customer 118. The customer 118 may make part payments using debit cards, credit cards, e-wallets, bank transfers, electronic cheques, mobile credit, bitcoin, etc. The processing fee is usually an amount agreed by the owner 120 for facilitating the booking event (i.e., booking of an animal). The payment processing module 234 is configured to calculate a payment amount for the owner based at least in part on the processing fee and the transaction amount. The server system is configured to facilitate receipt of at least a part payment for the animal booking request from the customer 118. The payment processing module 234 can issue a password and/or certification and the password/certificate for authorization to the user (e.g., owner 120 or customer 118).

The payment processing module 234 is further configured to determine a booking fee for each listed animal. In at least one example embodiment, the booking fee can be an amount suggested by the customer 118 (as a bid price), or an amount proposed by the owner 120 (as an offer price). Further, the difference between the bid price and the offer price is factored into the determination of the similarity score used to compile the list of match animals. In another example embodiment, the server 108 can also calculate a suggested viable booking fee for consideration by the owner 120 and the customer 118 based on past bookings.

The social media module 236 includes suitable logic and/or interfaces for connecting to social media accounts, social plug-ins, obtaining demographics, Interactive links of promotions, services of the account for analyzing content collected any of the social media account associated with the owner and/or the animal to determine a frequency of references and generates a report based on the analysis. The report may include details of visibility, followers, influencer references, social engagement value based on the plurality of social media posts and the like.

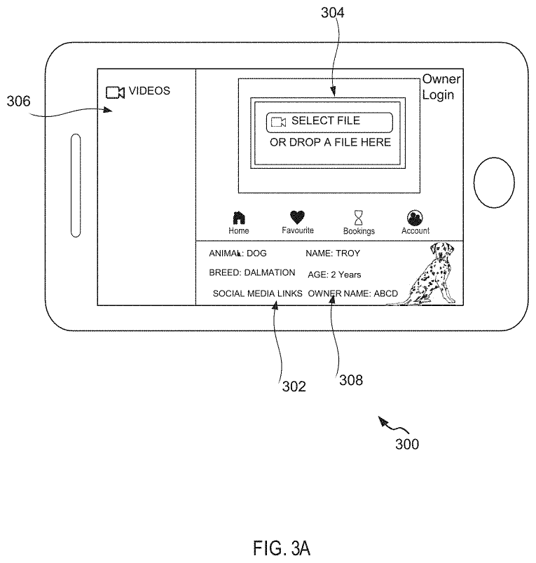

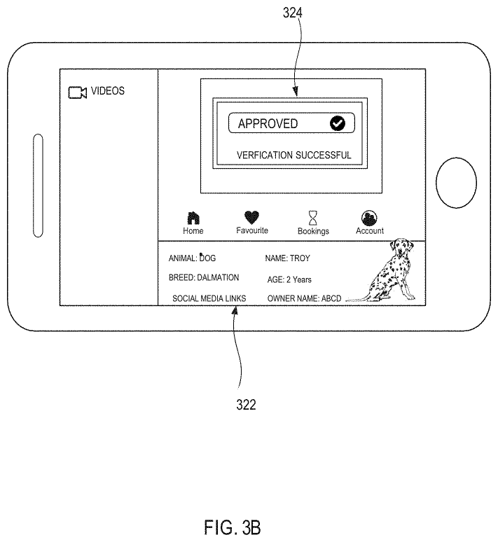

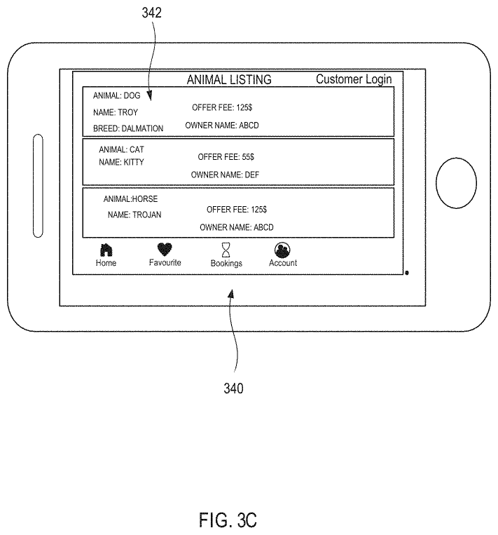

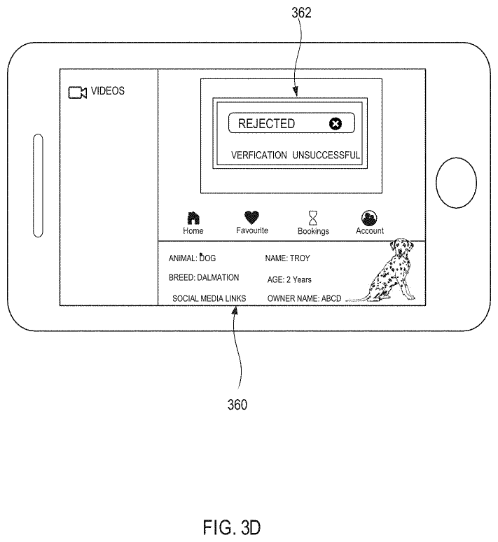

FIGS. 3A to 3D, collectively, represent an example representation of a process to be followed for submitting animal details with corresponding User Interfaces (UIs), in accordance with an example embodiment of the present disclosure.

A UI 300 displays a multimedia selection/upload page 302 as facilitated by the server system 108. The user (e.g., owner 120) can select/upload at least one animal details for which the owner wants to list the animal for booking an engagement. The page 302 displays one or more text fields 308. The user can fill the one or more fields 308 associated with the information of the animal or the owner. The user can select a file tab 304 displayed on the page 302. The user 102 can click on the select file tab 304 for accessing a multimedia file from a local drive of the user device or remote storage. Clicking on the select file tab 304 opens a screen with one or more links or tabs to select the specific multimedia file the user wants to access. The user selects a selects or can drag and drop the multimedia file that is to be upload for the animal listing.

As shown in FIG. 3B, a UI 320 displays a notification page 322 as facilitated by the server system 108. The media play page 322 includes a notification message 324 after successful validation of the uploaded details.

As shown in FIG. 3C, a UI 340 displays a listing page 342 facilitated by the server system 108. The listing page 342 displays the list of approved animals after successful verification and metrics determination, the owner 120 may click and select the respective animal details for accessing the complete information. The owner 120 may also edit the uploaded details the one or more editing options include but are not limited to copy, paste, cut and the like.

As shown in FIG. 3D, a UI 360 displays a notification page 362 as facilitated by the server system 108. The media play page 362 includes a notification message after unsuccessful validation of the uploaded details.

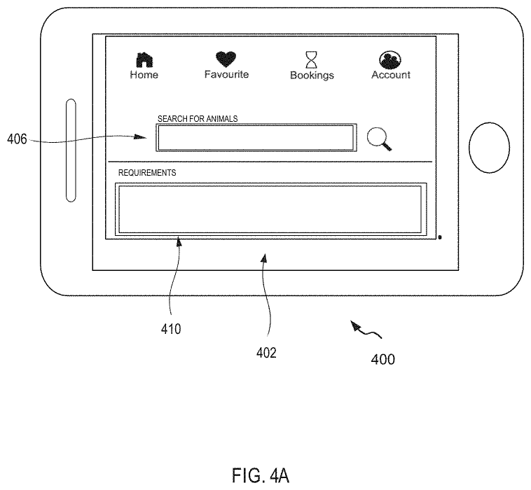

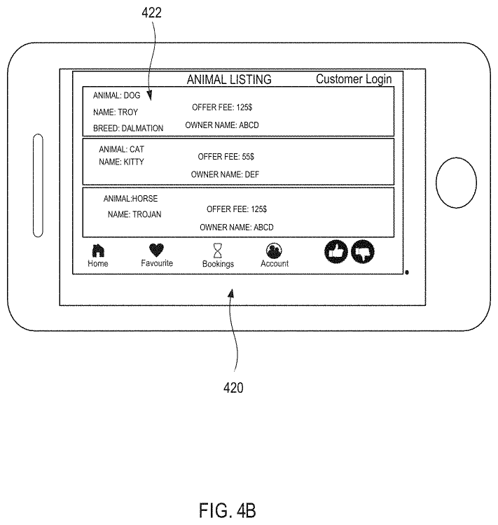

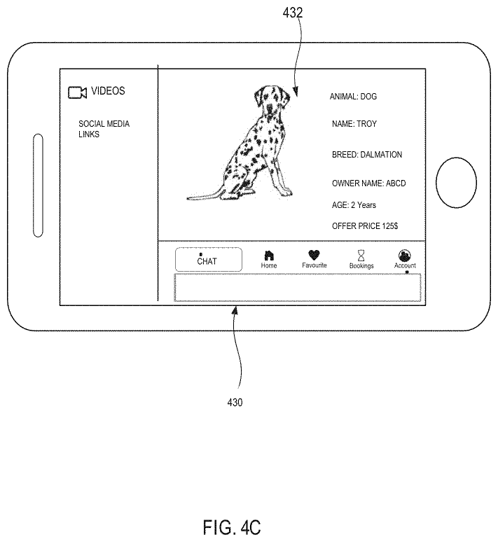

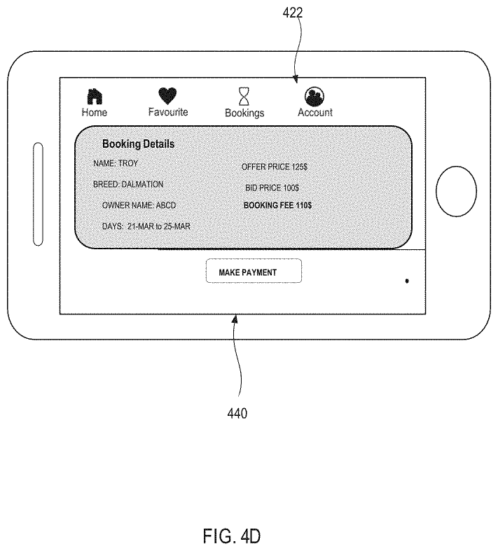

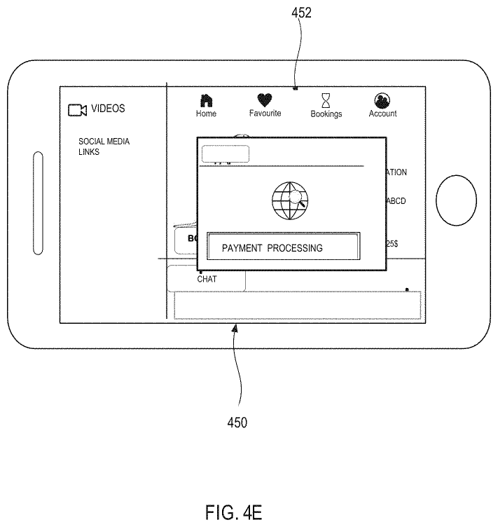

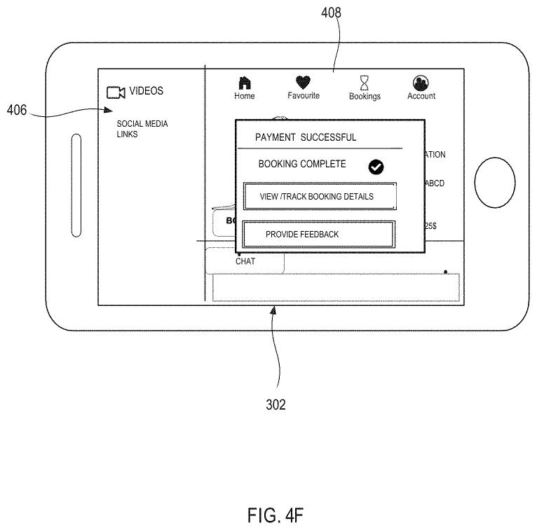

FIGS. 4A to 4F, collectively, represent an example representation of a process to be followed for booking an animal with corresponding User Interfaces (UIs), in accordance with an example embodiment of the present disclosure.

FIG. 4A, the UI 400 displays a search page 402 on the user device 104. The user 102 can search for at least one animal for a requirement through the search bar 408, the customer can enter the requirement details for a booking at 410. FIG. 4B, the UI 420 displays a list of qualified talent page 422 for the booking requirements on the user device 104. The list is generated in accordance with criteria provided by the customer at least based in part of the booking data provided by the customer entries. The server 108 then processes the received details by determining a similarity score and lists the matched animals on the customer device for the customer 118 to select and book one or more performing activities. The user can review the list to provide a vote by selecting an upvote/downvote for the provided list of recommendations. If the user selects the downvote the server 108 then list alternate recommendations.

FIG. 4C, the UI 430 displays the animal details page 432 selected from the list of qualifying talent. The customer may review the details and negotiate the terms of engagement with the owner through the chat option. The customer and the owner may negotiate a booking.

FIG. 4D, the UI 440 displays the booking details page 442, wherein the booking details include details of the animal, the dates of engagement, negotiated booking fee and the like. The customer 118 can review the booking details and make payment for the booking. the customer 118 may book an animal through the booking links provided by the server 108, for example, booking option may be a hypertext URL-based link to a corresponding booking for an animal. These booking links comprise a visual representation that is capable of clearly indicating to the customer 118 that the associated booking link may be used directly for making a booking. By way of a non-limiting example, the visual representation of a booking link may be a small image representing a booking option or instruction or words (e.g. ‘Book now’) or a booking tag, along with an accompanying, hypertext link. The visual representation may itself comprise the link where the booking instruction is visibly embodied in the link.

FIG. 4E, the UI 450 displays a payment processing pop window 452 for a selected booking and FIG. 4F displays a UI 460 with a pop up window for successful payment and booking confirmation. The user (e.g., customer 118 and owner 120) may also view/track the booking status and details. The user may also provide feedback by choosing the feedback feature.

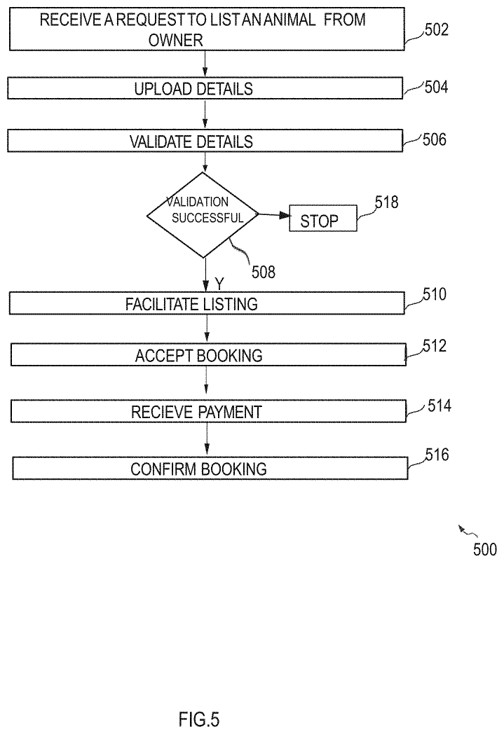

FIG. 5 is a flow diagram 500 of a process followed for listing and booking of an animal by an owner, in accordance with an example embodiment of the present disclosure. The steps of the flow diagram 500 may not be necessarily executed in the same order as they are presented. Further, one or more steps may be grouped and performed in form of a single step, or one step may have several sub-steps that may be performed in parallel or in a sequential manner.

The animal booking platform 110 at 502 receives a request to list an animal from an owner 120 associated with the owner device 106.

At 504, the animal booking platform 110 enables the owner 120 to upload one or more details associated with the animal booking, wherein the details may include the animal details, past experiences, performances and campaigns, and the owner details. External data including, but not limited to, social media engagement metrics (e.g., number of followers), demographics of followers, brand image compatibility, etc., are also collected and stored.

At 506, the animal booking platform 110 validates the details uploaded by the owner 120. The details validated, for example, include an animal's physical condition, permits and medical records where required. Other details, such as the temperament levels, training levels, and skills can be validated by the certified expert(s).

Wherein, each animal details are allocated under generic requirements to be included in the booking platform 110 through the platform's on-boarding process.

The uploaded details can also include generic metrics such as the social demographics, type of content of the campaign, content direction skills, lifestyle, number of animals owned and their specifics.

At 508, on successful validation and valuation, the owner 120 receives a notification and the animal details are stored and listed in an animal resource directory and directory database as approved talent. The stored animal details are listed publicly after, a certified expert or a trained machine-learning process has determined that the information for each animal is validated. In case of unsuccessful validation the process terminates at step 518.

At 510, the listing is displayed for other users to view and access. The owner 120 may access a booking post with campaign metrics posted by one or more customers or receive a booking request from a customer 118 with the booking details.

The certified trainer or expert works with the animals to assess an optimal value metrics for the animal Wherein, each animal undergoes a training process for each attribute defining the animal's abilities. Each ability is then assigned a value score and the valuation of each animal with its metrics and pricing is submitted to the scoring module 222 for further operations. This ensures an even distribution of the animals as per their abilities.

At 512, the owner 120 accepts the final booking once the terms and conditions of the negotiations are accepted. The server 108 may initiate the negotiation process by offering a standard form of terms and conditions for the booking that comply with laws and ethical criteria in effect at the time or location of the engagement.

At 514, the owner 120 receives, based on the agreed upon terms of the transaction, full payment at the completion of the engagement or a partial payment with the booking.

At 516, the owner confirms the booking.

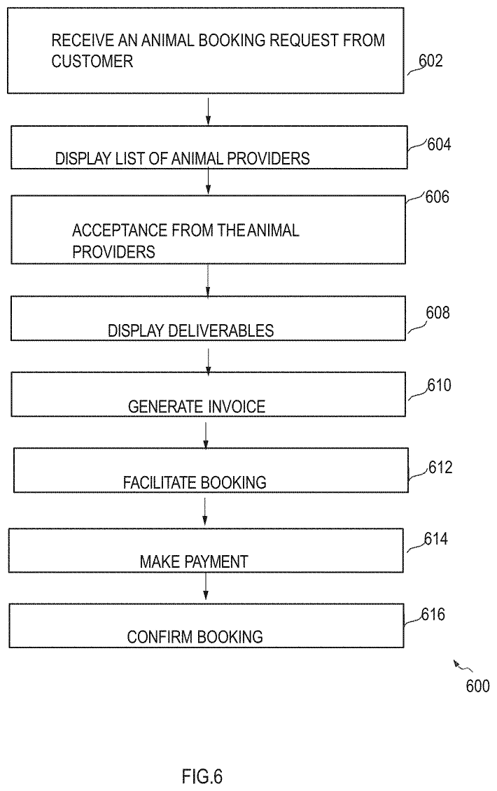

FIG. 6 is a flow diagram 600 of a process followed for booking of an animal by a customer, in accordance with an example embodiment of the present disclosure. The steps of the flow diagram 600 may not be necessarily executed in the same order as they are presented. Further, one or more steps may be grouped and performed in form of a single step, or one step may have several sub-steps that may be performed in parallel or in a sequential manner.

At 602, the animal booking platform 110 receives a request from the customer 118 to book an animal for an act. The request may include a search action using the animal resources directory 114 or the request may include campaign metrics created by the customer 108. The campaign metrics include the details specifying the customer's needs regarding animal skill-sets and budget. Each campaign metrics may also include a campaign advertisement. Advertisements are displayed with the campaign metrics along with additional details.

At 604, the animal booking platform 110 displays one or more optimally matched animals with their value score and/or the customer may receive a response request for the booking post from one or more owners through the platform.

At 606, the customer 118 may receive an acceptance from at least one owner 120 for the posted booking and campaign metrics. The animal booking platform 110 then registers an accepted campaign as an active campaign in the talent resources directory 114.

At 608, the animal booking platform 110 then generates campaign metrics and individual deliverables across various stages of the campaign to include the terms and the conditions of the contract.

The animal booking platform 110 may communicate with a communication tool (CT) to make adjustments to individual items before the final approval. The individual items may include but are not limited to the scope of work, pricing, and creative details (CD). The communication tool facilitates the incorporation of terms from both the owner and the customer for final approval.

At 610, the animal booking platform 110 generates an invoice for the customer based on the approved individual items and the estimates for the execution of the creative details including but not limited to logistics, training, preparation, content creation and the like.

At 612, the animal booking platform 110 displays the progress regarding animal talent imported for the customer 118 to review, update and/or provide the final approval of the progress. The approved final details are then stored and updated in the talent resources directory 114 and a booking acceptance request is transmitted to the owner 120 to facilitate the booking.

At 614, the customer makes a payment for the booking after receiving acceptance of terms and booking from the owner 120 through the communication tool provided by the animal booking platform 110.

At 616, the booking is confirmed.

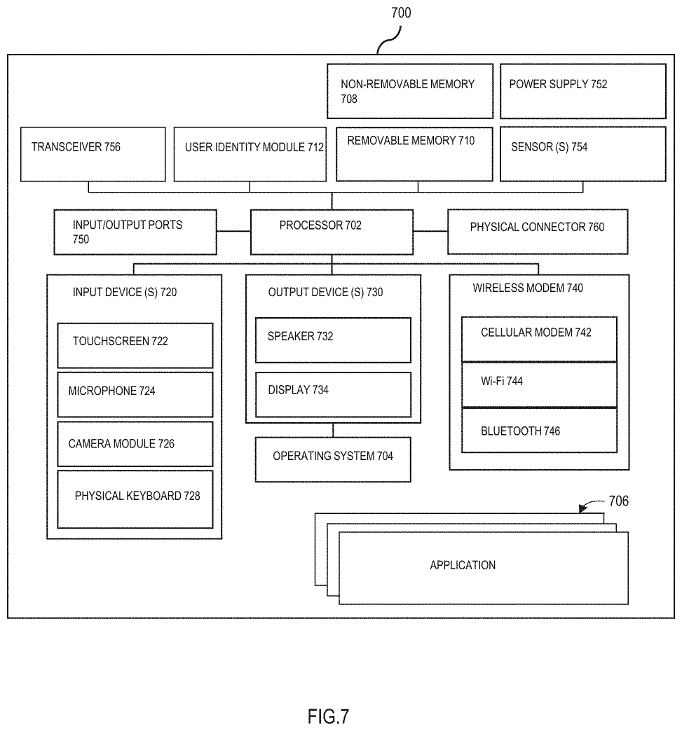

FIG. 7 shows a simplified block diagram of an electronic device 700 capable of implementing the various embodiments of the present disclosure. The electronic device 700 may be an example of the user device 102, 106. It should be understood that the electronic device 700 as illustrated and hereinafter described is merely illustrative of one type of device and should not be taken to limit the scope of the embodiments. As such, it should be appreciated that at least some of the components described below in connection with the electronic device 700 may be optional and thus in an example embodiment may include more, less, or different components than those described in connection with the example embodiment of the FIG. 7. As such, among other examples, the electronic device 700 could be any of an electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 700 includes a controller or a processor 702 (e.g., a signal processor, microprocessor, ASIC, or other control and processing logic circuitry) for performing such tasks as signal coding, data processing, image processing, input/output processing, power control, and/or other functions. An operating system 704 controls the allocation and usage of the components of the electronic device 700 and provides support for one or more programs such as a code analysis platform that implements one or more of the innovative features described herein. The electronic device 700 is depicted to include one or more applications such as the animal booking platform 110 facilitated by the server system 200/the server 108. The animal booking platform 110 can be an instance of an application 706 downloaded from the server system 200/the server 108 or a third-party server. The applications may further include common mobile computing applications (e.g., telephony applications, email applications, calendars, contact managers, web browsers, messaging applications such as USSD messaging or SMS messaging or SIM Tool Kit (STK) application) or any other computing application.

The illustrated electronic device 700 includes one or more memory components, for example, a non-removable memory 708 and/or a removable memory 710. The non-removable memory 708 and/or the removable memory 710 may be collectively known as storage device/module in an embodiment. The non-removable memory 708 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 704. The electronic device 700 may further include a user identity module (UIM) 712. The UIM 712 may be a memory device having a processor built-in. The UIM 712 may include, for example, a subscriber identity module (SIM), a universal integrated circuit card (UICC), a universal subscriber identity module (USIM), a removable user identity module (R-UIM), or any other smart card. The UIM 712 typically stores information elements related to a mobile subscriber. The UIM 712 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 700 can support one or more input devices 720 and one or more output devices 730. Examples of the input devices 720 may include, but are not limited to, a touch screen/a display screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video images) and a physical keyboard 728. Examples of the output devices 730 may include, but are not limited, to a speaker 732 and a display 734. Other possible output devices can include piezoelectric or other haptic output devices. Some devices can serve more than one input/output function. For example, the touch screen 722 and the display 734 can be combined into a single input/output device.

A wireless modem 740 can be coupled to one or more antennas (not shown in the FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth-equipped device or a local wireless data network or router, and/or a Bluetooth-compatible modem 746. The wireless modem 740 is typically configured for communication with one or more cellular networks, such as a GSM network for data and voice communications within a single cellular network, between cellular networks, or between the electronic device 700 and a public switched telephone network (PSTN).

The electronic device 700 can further include one or more input/output ports 750, a power supply 752, one or more sensors 754 for example, an accelerometer, a gyroscope, a compass, a global positioning system sensor (for providing location details) or an infrared proximity sensor for detecting the orientation or motion of the electronic device 700, a transceiver 756 (for wirelessly transmitting analog or digital signals) and/or a physical connector 760, which can be a USB port, IEEE 1294 (FireWire) port, and/or RS-232 port. The illustrated components are not required or all-inclusive, as any of the components shown can be deleted and other components can be added.

The present disclosure is described above with reference to block diagrams and flowchart illustrations of method and system embodying the present disclosure. It will be understood that various blocks of the block diagram and flowchart illustrations, and combinations of blocks in the block diagrams and flowchart illustrations, respectively, may be implemented by a set of computer program instructions. These set of instructions may be loaded onto a general-purpose computer, special-purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware, and software as described herein may also be employed.

Various embodiments described above may be implemented in software, hardware, application logic, or a combination of software, hardware, and application logic. The software, application logic, and/or hardware may reside on at least one memory, at least one processor, an apparatus or, a non-transitory computer program product. In an example embodiment, the application logic, software, or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the invention.

What is claimed is:

1. A computer-implemented method comprising an animal booking platform incorporated in a server system configured to perform the steps of:
receiving, by the server system, an animal listing request from an owner for listing an animal;
uploading, by the server system, one or more records associated to at least a part of the animal listing request;
validating, by the server system, the animal listing request based at least on part of one or more submitted records provided by the owner;
receiving, by the server system, scoring parameters associated with the animal listing request, and computed qualification score for the animal that qualifies the pre-determined standards and obligations of the engagement, wherein the qualification score is computed based on the data extracted from the third party evaluation data providers;
listing, by the server system, the animal listing request after successful validation and determination of qualified metrics as approved talent; and
sending, by the server system, a notification to the owner with the status of the listing and result of the validation.

2. The computer-implemented method as claimed in claim 1, further comprising:
receiving, by the server system, an animal booking request from a customer for booking an animal for an engagement;
determining, by the server system a similarity score and generating a list of qualifying animals in accordance with the animal booking request provided by the customer;
facilitating, by the server system, selecting and booking of at least one qualifying animal; and
facilitating, by the server system, receipt of at least a part payment for the animal booking request from the customer to the owner.

3. The computer-implemented method as claimed in claim 1, wherein the animal listing request includes at least an animal information comprising at least animal type, animal physiology, animal biochemistry, data describing a physical condition of the animal, data describing the medical diagnosis of the animal, location, activity strength, temperament testing, training level and skills.

4. The computer-implemented method as claimed in claim 1, wherein the records include supporting information for an animal in the form of text, image, audio, video or any combination thereof.

5. The computer-implemented method as claimed in claim 1, further comprising:
computing value scores for the received parameters that are stored in the talent resource directory; and
computing value metrics from the generated value scores, wherein the value metrics are displayed to the user with the animal listing for the user to choose an animal as per one's requirement.

6. The computer-implemented method as claimed in claim 1, wherein the scoring parameters include at least one quantitative, qualitative, and extraneous factors.

7. The computer-implemented method as claimed in claim 1, wherein the validation is performed to facilitate determining the content accuracy prior to listing of the animals.

8. The computer-implemented method as claimed in claim 2, wherein the engagement can include but is not limited to casting, performing at an event, marketing campaign or any other activity that fulfills the governmental licensing requirements and/or social/moral obligations.

9. The computer-implemented method as claimed in claim 2, wherein the animal book request includes one or more metrics associated with the activity, and required talent and/or skill details for the engagement.

10. The computer-implemented method as claimed in claim 1, further comprising:
facilitating, by the server system, negotiation between the customer and the owner to negotiate mutually acceptable terms; and
enforcing automatically, by the server system, the agreed terms of the engagement.

11. The computer-implemented method as claimed in claim 1, further comprising:
enabling, by the server system, a certified expert to conduct meetings with the owner and work with the animals, inquire about the owner and other accomplices and/or refer to external databases to validate the authenticity of the animal details and animal's condition.

12. The computer-implemented method as claimed in claim 1, further comprising:
listing, by the server system, a booking fee for the listed animal, wherein the booking fee can be an amount suggested by the customer, or an amount proposed by the owner or the difference between the bid price and the offer price is factored into the determination of the similarity score used to compile the list of match animals.

13. The computer-implemented method as claimed in claim 1, further comprising:
collecting, by the server system, quantitative post-engagement data related to the outcome of the engagement in terms of the fulfillment of stated objectives by the customer and the owner; and
calculating, by the server system, value metrics using the qualitative feedback and quantitative post-engagement data for providing future animal booking recommendations for similar successful bookings.

14. A server system, comprising:
a memory configured to store instructions; and
a processor configured to execute the instructions stored in the memory and thereby cause the server system to:
receive an animal listing request from an owner for listing an animal;
upload one or more records associated to at least a part of the animal listing request;
validate the animal listing request based at least in part on one or more submitted records provided by the owner;
receive scoring parameters associated with the animal listing request, and computed qualification score for the animal that qualifies the pre-determined standards and obligations of the engagement, wherein the qualification score is computed based on the data extracted from the third party evaluation data providers;
list the animal listing request after successful validation and determination of qualified metrics as approved talent; and
send a notification to the owner with the status and result of the validation.

15. The server system as claimed in claim 14, further comprising,
receive an animal booking request from a customer for booking an animal for an engagement;
determine a similarity score and generate a list of qualifying animals in accordance with the animal booking request provided by the customer;
facilitate selecting and booking of at least one qualifying animal; and
facilitate receipt of at least a part payment for the animal booking request from the customer to the owner.

16. The server system as claimed in claim 15, wherein the animal listing request includes at least an animal information comprising at least one of animal type, animal physiology, animal biochemistry, data describing a physical condition of the animal, data describing the medical diagnosis of the animal, location, activity strength, temperament testing, training level and skills.

17. The server system as claimed in claim 15, wherein the records include supporting information for an animal in the form of text, image, audio, video or any combination thereof.

18. The server system as claimed in claim 14, further comprising:
computing value scores for the received parameters that are stored in the talent resource directory; and
computing value metrics from the generated value scores, wherein the value metrics are displayed to the user with the animal listing for the user to choose an animal as per one's requirement.

19. The server system as claimed in claim 14, wherein the scoring parameters include at least one quantitative, qualitative, and extraneous factors.

20. The server system as claimed in claim 15, wherein the validation is performed to facilitate determining the content accuracy prior to display and listing of the animals.

21. The server system as claimed in claim 15, wherein the engagement can include but is not limited to casting, performing at an event, marketing campaign or any other activity that fulfills the governmental licensing requirements and/or social/moral obligations.

22. The server system as claimed in claim 15, wherein the animal book request includes one or more metrics associated with the activity, and required talent and/or skill details for the engagement.

23. The server system as claimed in claim 14, further comprising:
facilitating, by the server system, negotiation between the customer and the owner to negotiate mutually acceptable terms; and
enforcing automatically, by the server system, the agreed terms of the engagement.

24. The server system as claimed in claim 14, further comprising: enabling, by the server system, a certified expert to conduct meetings with the owner and work with the animals, inquire about the owner and other accomplices and/or refer to external databases to validate the authenticity of the animal details and animal's condition.

25. The server system as claimed in claim 14, further comprising:
collecting, by the server system, quantitative post-engagement data related to the outcome of the engagement in terms of the fulfillment of stated objectives by the customer and the owner; and
calculating, by the server system, value metrics using the qualitative feedback and quantitative post-engagement data for providing future animal booking recommendations for similar successful bookings.

26. A system comprising:
a memory configured to store instructions;
a communication interface; and
a processor in communication with the memory and the communication interface, the processor configured to execute the instructions stored in the memory and further comprising:
a scoring module configured to receive scoring parameters which include at least one of quantitative, qualitative, extraneous factors, and qualification score computed for the animal that qualifies the pre-determined standards and obligations associated with an animal for performing an activity, wherein the qualification score is computed based on the data extracted from the third party evaluation data providers,
a metrics module configured to compute value metrics from one or more value scores,
a feedback & rating module configured to receive and collect ratings and qualitative feedback in response to the information of listings and provide alternative recommendations based on the feedback,
a logistics engine configured to track, and generate reports for successful bookings and enables deep search capability to compare animals that match the talent criteria with the associated animal booking request,
a validation module configured to validate the uploaded records to determine content accuracy of the animal information prior to display of the animal listing,
a fitness determination module configured to generate health, wellness, and fitness profile and health score for animals that choose to participate in an engagement, and
a payment processing module configured to facilitate receipt of at least a part payment for the booking made by the customer.
